(19) United States
(12) Patent Application Publication
(10) Pub. No.: US 2017/0330282 A1
(43) Pub. Date: Nov. 16, 2017

(54) Roof Monitoring Tools And Methods Of Use

(71) Applicant: NSP Technologies, LLC, Dayton, OH (US)

(72) Inventors: Phillip Pratt, Maineville, OH (US); Jamie Elizondo, Dayton, OH (US)

(73) Assignee: NSP Technologies, LLC, Dayton, OH (US)

(21) Appl. No.: 15/591,211

(22) Filed: May 10, 2017

Related U.S. Application Data
(60) Provisional application No. 62/333,919, filed on May 10, 2016.

(51) Int. Cl. G06Q 40/08; E04D 13/00; G06F 21/62; G06Q 50/16; G06Q 10/00; G06F 3/0484

(52) U.S. Cl. CPC G06Q 40/08; G06Q 50/16; G06Q 10/20; E04D 13/00; G06F 21/6209; G06F 3/04847

(57) ABSTRACT

Methods and systems for utilizing a central portal to store a history of roof information for a building with corresponding weather information associated with the building over a period of time. For example, the portal receives benchmark information regarding a roof inspection at a location, monitors weather associated with the location within one or more set weather parameters, displays a condition of the roof in real-time with an associated color-code marker that visually indicates the condition, triggers an alert to users at various levels of security clearance and a notification of a damage inspection based on severe weather reporting at least partially based on the set weather parameters, and stores information from the damage inspection and a determination of roof condition based on the damage inspection of potential roof damage.

### CROSS REFERENCE TO RELATED APPLICATIONS

The present specification claims priority to U.S. Provisional Patent Application Ser. No. 62/333,919, filed May 10, 2016, and entitled “ROOF MONITORING TOOLS AND METHODS OF USE,” the entirety of which is incorporated by reference herein.

### TECHNICAL FIELD

The present specification generally relates to system application tools to monitor roofs of buildings and/or residential units over a period of time and, more specifically, to monitor the roofs with respect to weather incidents and to store reports based on the monitoring within a central portal and methods of use of such tools.

### BACKGROUND

In the insurance industry, claims of roof damage are typically submitted without much opportunity for or possibility of verification to investigate the background of the claim. Due to such lack of appropriate claim verification opportunities, insurance companies may pay funds for questionable claims that are submitted by potentially unscrupulous companies and individuals.

Accordingly, a need exists for alternative tools to streamline and control the process associated with verifying roof damage claims through an accessible portal and methods of use of such tools.

### SUMMARY

In one embodiment, a method for utilizing a computing device to store a history of roof information for a building with corresponding weather information associated with the building over a period of time may include storing a set of parameters for the roof indicative of potential roof damage conditions; monitoring weather associated with the roof; automatically storing, via a processor of the computing device, the monitored weather as stored weather data associated with the roof; and triggering, via the processor, an alert based on the stored weather data meeting at least one parameter of the set of parameters for the roof.

In another embodiment, a system for utilizing a computing device to store a history of roof information for a building with corresponding weather information associated with the building over a period of time may include a server communicatively coupled to the computing device, a processor communicatively coupled to the server, and a non-transitory computer-readable storage medium storing one or more instructions. The one or more instructions may, when executed by the processor, cause the processor to: store a set of parameters for the roof indicative of potential roof damage conditions; monitor weather associated with the roof through a weather monitoring application communicatively coupled to the computing device; automatically store the monitored weather as stored weather data associated with the roof; and trigger an alert based on the stored weather data meeting at least one parameter of the set of parameters for the roof.

In yet another embodiment, a system for utilizing a computing device to store a history of roof information for a building with corresponding weather information associated with the building over a period of time may include a graphical user interface of the computing device, a server communicatively coupled to the computing device, a processor communicatively coupled to the server, and a non-transitory computer-readable storage medium storing one or more instructions. The one or more instructions may, when executed by the processor, cause the processor to: store a set of parameters for the roof indicative of potential roof damage conditions; monitor weather associated with the roof through a weather monitoring application communicatively coupled to the computing device; automatically store the monitored weather as stored weather data associated with the roof; display one or more color-coded conditions of at least the roof in real-time on a map on the graphical user interface of the computing device based on the set of parameters for the roof and the stored weather data associated with the roof; and trigger an alert based on the stored weather data meeting at least one parameter of the set of parameters for the roof.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a schematic illustration of levels of accessibility associated with a central portal of an example tool to access a stored history of roof information for a building with corresponding weather information over a period of time, according to one or more embodiments shown and described herein;

FIG. 2 is a flow chart of a process for using a central portal to store a history of roof information for a building with corresponding weather information over a period of time, according to one or more embodiments shown and described herein;

FIG. 3 schematically illustrates a system for implementing computer and software based methods to utilize the tools of FIGS. 1 and/or 2 to use the central port to access and store history of roof information for a building with corresponding weather information over a period of time, according to one or more embodiments shown and described herein;

FIG. 4 illustrates an example graphical user interface (GUI) associated with the tool of FIG. 1 that shows a example photograph of an elevation of a roof and an assigned condition status of a good condition, according to one or more embodiments shown and described herein;

FIG. 5 illustrates an example GUI associated with the tool of FIG. 1 that shows a photograph associated with another roof elevation and associated recorded answers from a roof inspection, according to one or more embodiments shown and described herein;

FIG. 6 illustrates an example GUI associated with the tool of FIG. 1 and including a customer portal welcome page, according to one or more embodiments shown and described herein;

FIG. 7 illustrates an example GUI associated with the tool of FIG. 1 and including a menu selection and history report page, according to one or more embodiments shown and described herein;

FIG. 8 illustrates an example GUI associated with the tool of FIG. 1 and including color-coded indicators of roof conditions of customer home-owners based on weather related factors, according to one or more embodiments shown and described herein; and

FIG. 9 illustrates an example GUI associated with the tool of FIG. 1 displaying a severe weather activity report that includes an impact details section and a historical storm activity section, according to one or more embodiments shown and described herein.

### DETAILED DESCRIPTION

Referring generally to the figures, embodiments of the present disclosure are directed to utilizing a central portal to store a history of roof information for a building with corresponding weather information associated with the building over a period of time. The roof information is, for example, information that is indicative and informative of a roof condition of a roof, such as a good, bad, or fair condition, that is based on associated roof properties of the roof, such as visual and/or otherwise sensed recordable roof wear and tear, a visual and/or otherwise sensed recordable state of one or more shingles of the roof as, for example, damaged or undamaged, with specific description of any noted damage, and the like. The portal may, for example, receive benchmark information regarding a roof inspection at a location, monitors weather associated with the location within one or more set weather parameters, displays a condition of the roof in real-time with an associated color-code marker that visually indicates the condition, triggers an alert to users at various levels of security clearance and a notification of a damage inspection based on severe weather reporting at least partially based on the set weather parameters, and stores information from the damage inspection and a determination of roof condition based on the damage inspection of potential roof damage.

Wherever possible, the same reference numerals will be used throughout the drawings to refer to the same or like parts. Various embodiments of the tools will be described in further detail herein with specific reference to the appended drawings.

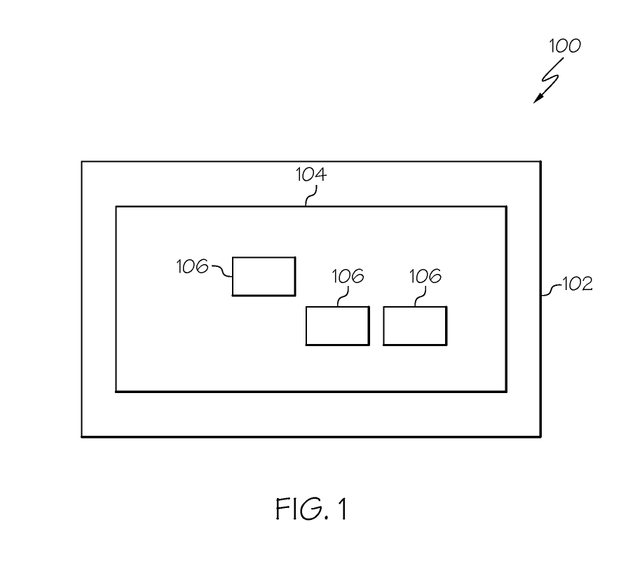

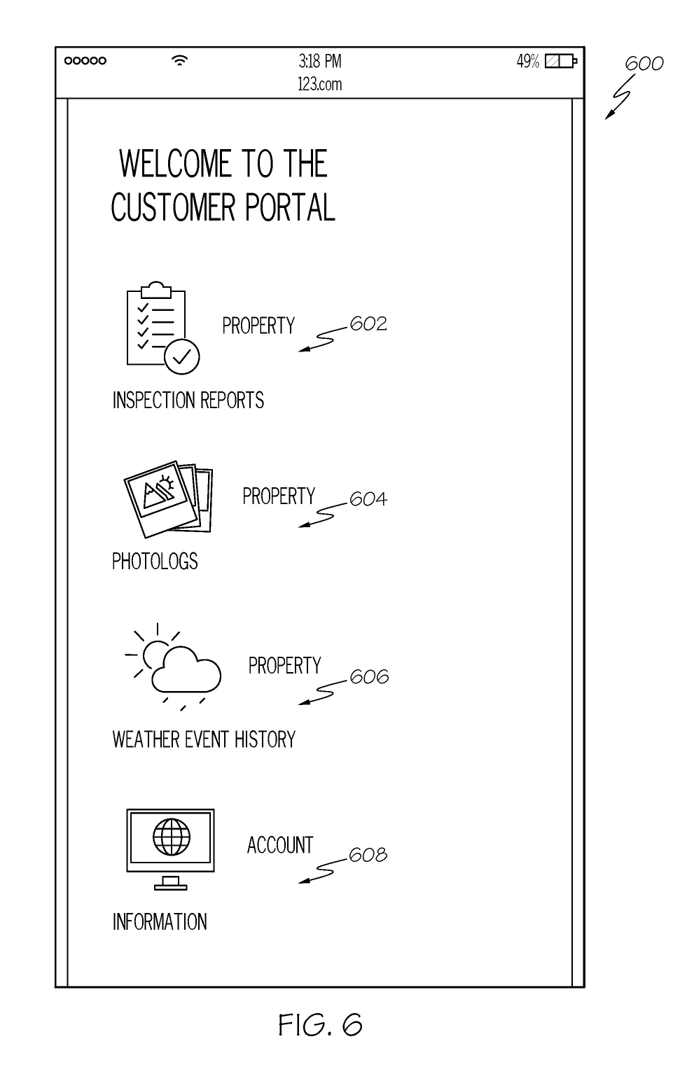

The tool described herein includes multiple levels of accessibility and/or security clearance for users (through, for example, user login and password identification processes) having one or more assigned user levels of one or more levels associated with respective security clearance rights. For example, referring to FIG. 1, a tool 100 includes an overall accessibility level 102 for an agency supporting a number of inspectors and/or for tool administrators (or single administrator). The agency, tool administrators, and/or other users assigned rights to access the overall accessibility level 102 may have specific associated clearance rights. Alternatively, such users may only have rights to specific levels or portions of the tool. Further, for example, the tool 100 includes an inspector level 104. An inspector may have security clearance to access the inspector level 104 and view a number of customer reports (such as one of a plurality of customer reports 106) associated with customers assigned to the inspector. A specific customer may have access rights to his or her specific, respective customer report 106 via, for example, a customer-specific level of security clearance. The tool 100 may be, for example, a software application associated with a computer, such as a desktop or laptop, and/or a portable mobile device, such as an application on a smartphone or other smart device. The tool 100 may be shared on cloud-based devices communicatively coupled to each other and a server including the central portal, as described in greater detail below. For example, FIG. 6, described in greater detail further below, shows a GUI 600 as welcome screen interface of a customer portal shown to a user that has logged into a customer portal of tool 100, which interface includes property inspection reports 602, property photologs 604, property weather event history 606, and other account information 608 for the user to access.

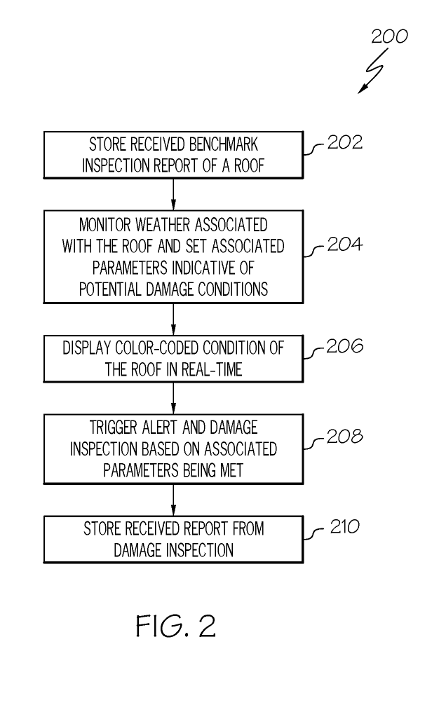

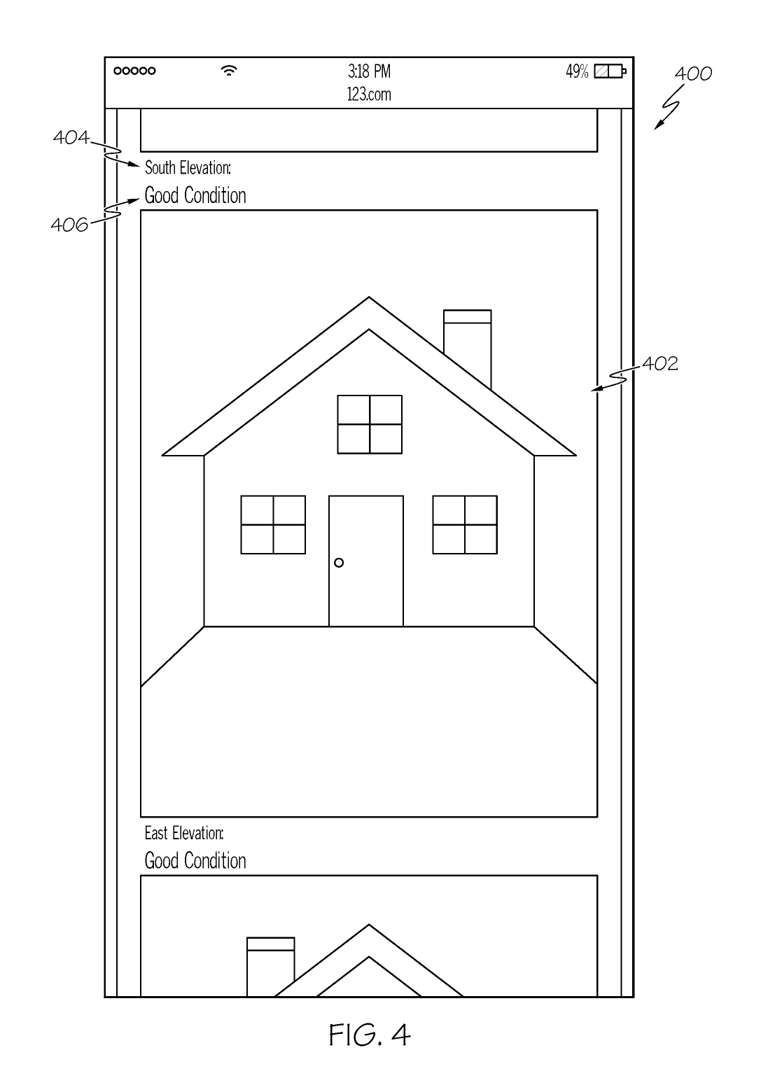

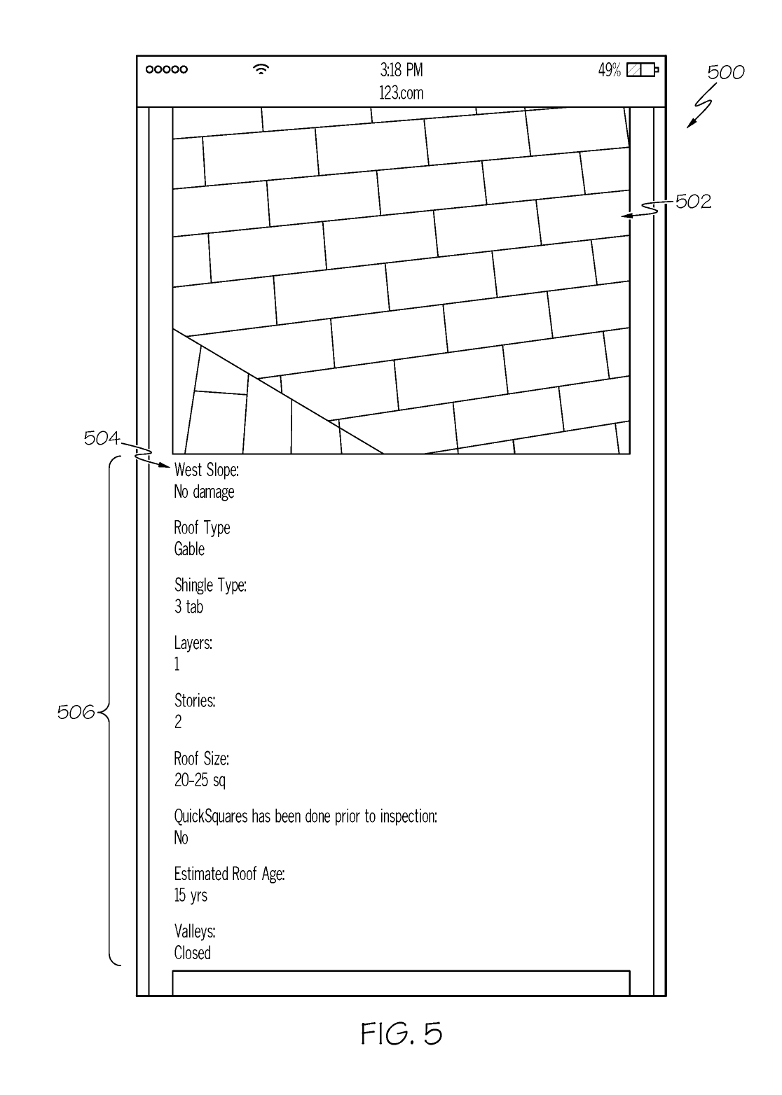

FIG. 2 illustrates a flow chart of a process 200 for using the tool 100 that includes a central portal to store a history of roof information for a plurality of buildings with corresponding weather information over a period of time. Typically, roof inspectors catalogue an inspection of a roof by taking pictures of the roof at different building elevations and assigning roof condition notes to each picture. In embodiments, the tool described herein provides a questionnaire for such inspectors to fill out when inspecting a roof, either at an initial benchmark inspection or for subsequent inspections. The completed questionnaire may be stored as an inspection report in the central portal communicatively coupled with the tool. The roof inspectors may additionally store associated photos taken at different elevations with notes within the central portal and link the photos with the stored inspection report stored in the central portal. In step 202 of FIG. 2, the received information associated with a benchmark inspection report (that may include the completed questionnaire and associated roof and/or other building related photographs) is stored in a database, for example, of the tool 100. Such a benchmark report may include information as reflected in FIGS. 4-5, for example.

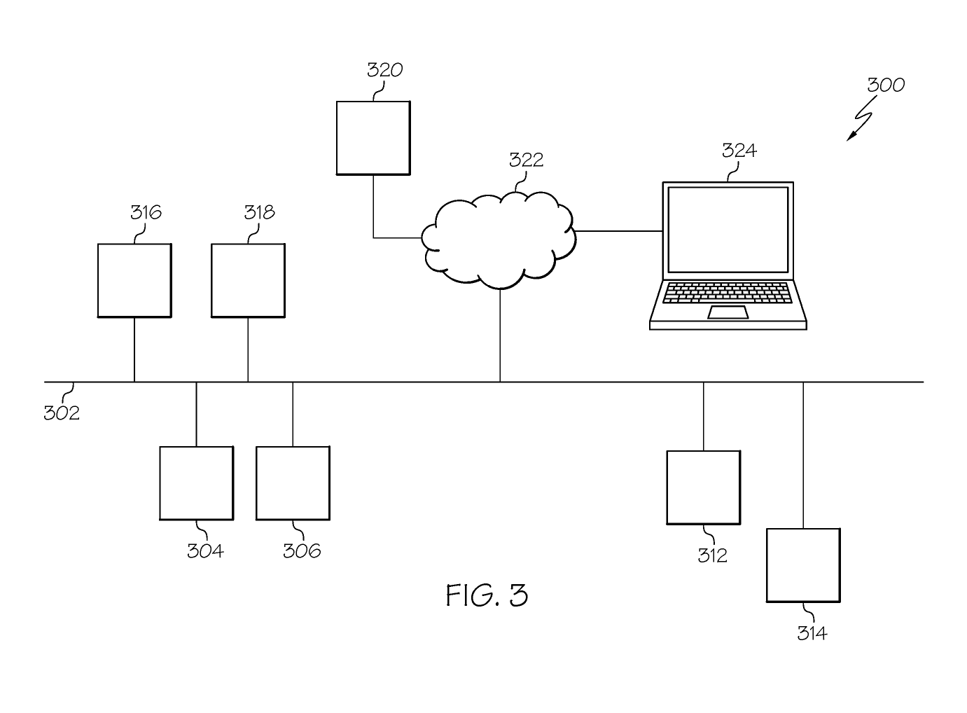

FIG. 4 illustrates an example GUI 400 associated with the tool 100 of FIG. 1 and implemented by the system of FIG. 3, which is described in greater detail further below. The GUI 400 shows a example photograph 402 of an elevation of a roof and an assigned condition status of a good condition. For example, the photograph 402 is of a south elevation 404 and the roof at the south elevation 404 has an condition 406 recorded as a good condition at least partially based on the photograph 402 at the south elevation 404.

FIG. 5 illustrates an example GUI 500 associated with the tool 100 of FIG. 1 and implemented by the system of FIG. 3. The GUI 500 that shows a photograph 502 associated with another roof elevation recorded as a west slope 504 and associated recorded answers and information 506 from a roof inspection. For example, the west slope 504 is noted to have no damage, and to have the following features: a gable roof type, a 3 tab shingle of 1 layer, be associated with a 2 story building, have a roof size of 20-25 square feet, have an indication of any previous applications (such as the indication that an application named QuickSquares was not applied to the roof prior to the inspection being recorded), an estimated roof age of 15 years, and a listing of closed roof valleys. For example, for a closed valley listing, shingles cover a self-adhering underlayment to close the roof valley area and act as the valley lining and wearing surface to protect against water run-off. In contrast, open roof valleys add an additional layering of lining into the valley such that covering shingles are cut out from a valley area to open a surface of the valley lining to water run-off and the environment.

A customer such as a homeowner of a particular building that such a benchmark report has been stored for may report roof damage due to, for example, severe weather. Additionally or alternatively, another company may report such damage on the customer's behalf. An inspector may be dispatched to document the reported roof damage. However, an inspector may not have other means to verify the validity of the roof damage claim. While the inspector may have personal knowledge to attempt to contest such a claim, such as viewing a shingle being damages at roof angles that does not correspond with typical wind directions during a storm, it is difficult for an inspector to contest such a claim without additional documented verification.

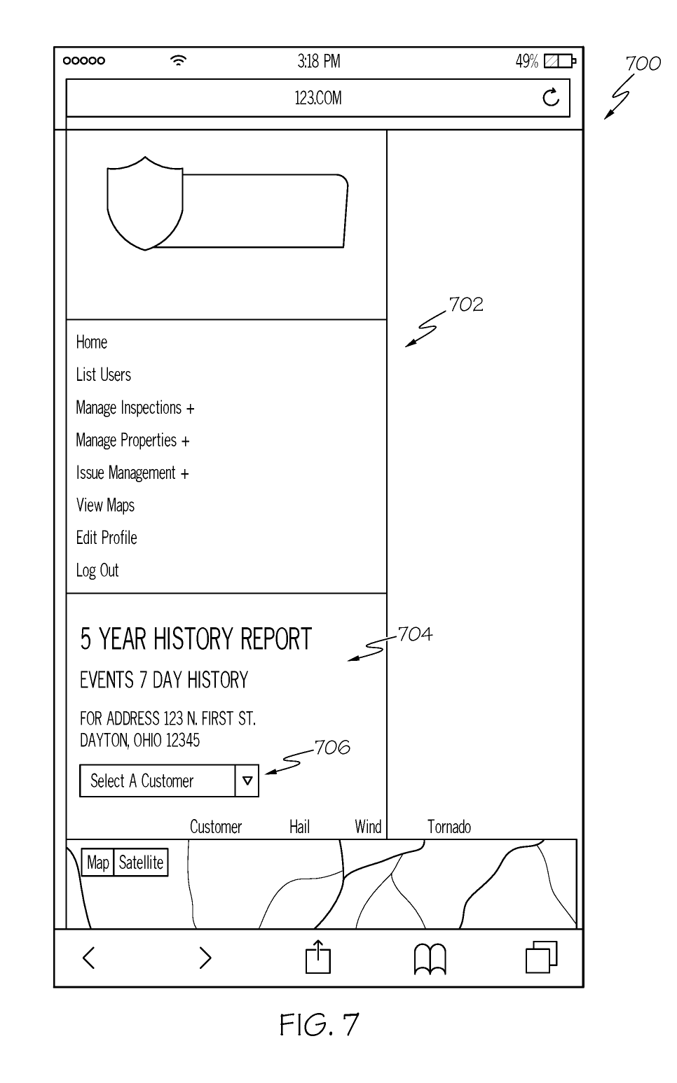

An inspector with tool 100 may now access such additional documentation for verification purposes by acting as a user that is able to login to an interface of the tool 100 to be presented with, for example, the GUI 600 of FIG. 6 illustrating a customer portal welcome page from which to access information such as reports, photographs, weather event history, and/or account information, and/or the GUI 700 illustrating a menu selection of options for a user that has logged into the tool 100. For example, FIG. 6 illustrates an example GUI 600 associated with the tool 100 of FIG. 1 and implemented by the system of FIG. 3, which is described in greater detail further below. The GUI 600 includes a customer portal welcome page including one or more hyperlinks to access property inspection reports 602, property photologs 604, property weather event history 606, which may include, for example, one or more weather event history related reports on another GUI display, and account information 608. Further, FIG. 7 illustrates an example GUI 700 associated with the tool 100 of FIG. 1 and implemented by the system of FIG. 3, described in greater detail further below. The GUI 700 includes a menu selection 702, including a listing of menu options and drop-down feature for a user to select the options, and a history report option 704 for a customer that is selectable by a user via a drop-down menu 706. For example, the GUI 700 includes a 5 year history report for a specific address from a plurality of addresses and presents an option to view a history of events, such as weather related events as described herein, as a weather history report for the roof over a 7 day window of time (i.e., from a portion of a period of time of stored weather data) through the history report option 704 for the specific address and/or for a customer selected through the drop-down menu 706.

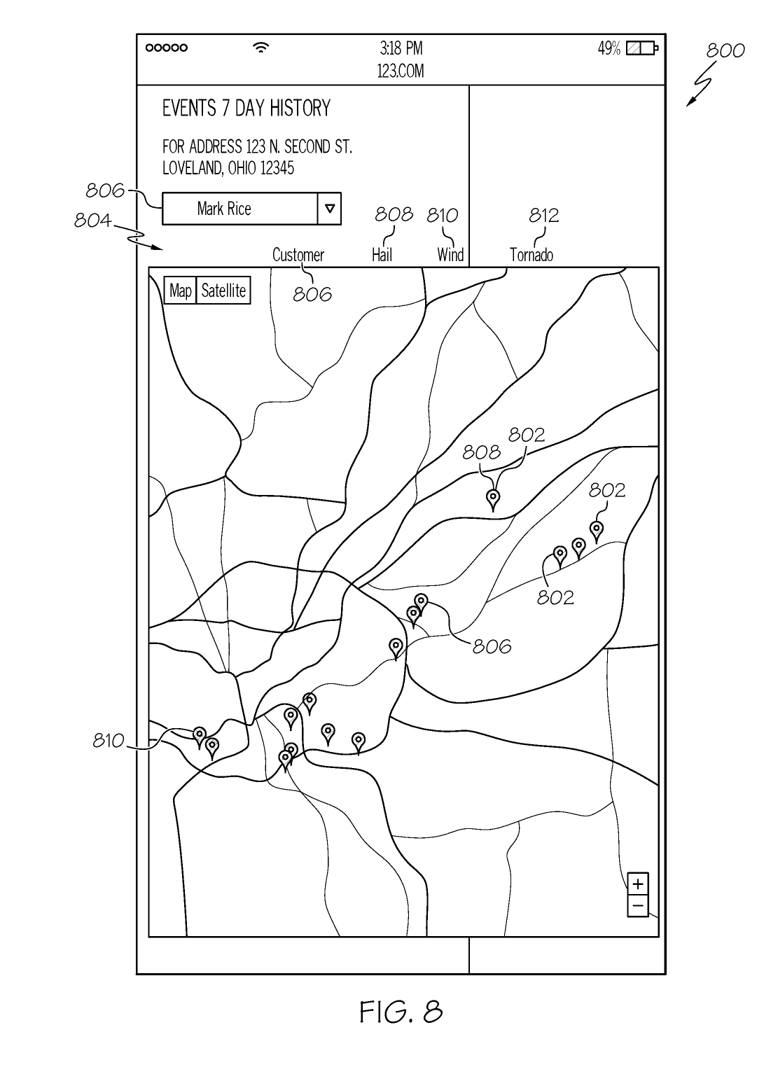

The process 200 in step 204 provides such additional verification methodologies by monitoring weather that is associated with the roof within associated parameters that are set to be indicative of potential damage conditions. In embodiments, the tool 100 may use a mapping application that uses, for example, global positioning sensor (GPS) technologies or other like mapping technologies to provide a visual map for electronic display of an area surrounding a particular home or building (or plurality of homes or buildings) that is being monitored by the tool 100. The GUI 800 of FIG. 8, described in greater detail further below, illustrates such an example mapping application of the tool 100. FIG. 8 illustrates an example GUI 800 associated with the tool 100 of FIG. 1 and implemented by the system of FIG. 3. The GUI 800 is shown as an extension of the GUI 700, (e.g., a bottom of the screen of the GUI 700) and includes one or more color-coded indicators of roof conditions of customer home-owners based on weather related factors, as described in greater detail below.

In embodiments, the tool 100 may be used for other industries, such as for personal home management (when a homeowner is remotely monitoring the home, for example) and/or for uses in real estate such that real estate agents may monitor the homes and/or provide associated leak guarantees when appropriate based on the monitored home reports. The weather may be monitored by a service such as through the National Weather Service's National Oceanic and Atmospheric Administration (“NOAA”) system to track weather across the United States, and other like electronic weather tracking services globally, and updated within the tool frequently, such as at about every 15 seconds. The parameter associated with the update time frequency may be adjustable within the tool 100.

The associated parameters may be set, for example, by an inspector and/or higher-security level user or may be automatically generated by the tool 100 per an algorithm associated with a type of roof or home such that the associated parameter setting is at least partially based on an a type and/or age of a roof. For example, an older roof of greater than a range of from about 10 to 15 years in age may have a parameter of an inch (1″) of hail set within the tool 100. Thus, the tool 100 is instructed that hail greater than 1″ would possibly cause damage to the older roof (i.e., a set old roof hail parameter for hail accumulation of greater than 1 inch for a roof age of the roof that is greater than about 10 years). A new roof of an age of less than a range of from about 10 to 15 years may be stronger and may be able to incur more hail. Thus, the new roof may have a parameter of 1.75″ of hail that is set within the tool 100 (i.e., a set new roof hail parameter for hail accumulation of greater than 1.75 inches for a roof age of the roof that is less than about 10 years). Thus, the tool 100 is instructed that hail greater than 1.75″ would possibly cause damage to the new roof.

Further, parameters may be distinguished by age and/or type of roof or may be set to be consistent across roofs (while the parameters still may be adjustable to be different for different types and/or ages of roofs). For example, a set wind parameter for all roofs may include setting a parameter for wind gusts in a range of between 20 to about 40 miles per hour (mph). Additionally or alternatively, set potential tornado parameters may follow a scale, such as the Fujita scale, such that wind speeds are set in categories ranging from a first level associated with wind speeds in the range of from about 40 to 72 mph (i.e., a set first level potential tornado parameter for wind gusts in a range of from about 40 miles per hour to about 72 miles per hour), a second level associated with wind speeds in the range of from about 73 to 112 mph (i.e., a set second level potential tornado parameter for wind gusts in a range of from about 73 miles per hour to about 112 miles per hour), a third level associated with wind speeds in the range of from about 113 to 157 mph (i.e., a set third level potential tornado parameter for wind gusts in a range of from about 113 miles per hour to about 157 miles per hour), a fourth level associated with wind speeds in the range of from about 158 to 206 mph (i.e., a set fourth level potential tornado parameter for wind gusts in a range of from about 158 miles per hour to about 206 miles per hour), a fifth level associated with wind speeds in the range of from about 207 to 260 mph (i.e., a set fifth level potential tornado parameter for wind gusts in a range of from about 207 miles per hour to about 260 miles per hour), a sixth level associated with wind speeds in the range of from about 261 to 318 mph (i.e., a set sixth level potential tornado parameter for wind gusts in a range of from about 261 miles per hour to about 318 miles per hour), and/or a seventh level associated with wind speeds greater than 318 mph (i.e., a set seventh level potential tornado parameter for wind gusts greater than 318 miles per hour).

In step 206, the process 200 may display current conditions of the roof in real-time on a visual display screen associated with the tool 100. For example, a roof with no currently reported damage may have a display color of white (i.e., a first color-coding indicative of no current damage) and/or a roof of a specific customer may have a display color of green. Thus, a color-coded condition of one or more color-coded conditions displaying map roof data from a plurality of roof data respectively associated with a plurality of buildings may include a green color-coding indicative of the roof from the plurality of roof data respectively associated with a plurality of buildings stored in the computing device. The green color-coding may be indicative of a position of the roof on a map as illustrated in FIG. 8 and described in greater detail below. A roof that has indicated reported damage, as described further below, may have other associated color coding. For example, wind damage may be associated with a blue color-coding (i.e., a second color-coding indicative of wind damage and different from the first color-coding), hail damage may be associated with a grey color-coding (i.e., a third color-coding indicative of hail damage and different from the first color-coding and the second color coding), and/or tornado damage may be associated with a red color-coding (i.e., a fourth color-coding indicative of tornado damage and different from the first color-coding, the second color-coding, and the third color-coding). The green color-coding may be a fifth color-coding different from the first color-coding, the second color-coding, and the third color-coding. The color-coding may show roof conditions as reported within a 7-day window, though this window may be adjustable by a user, for example.

The GUI 800 of FIG. 8, for example, illustrates such an example color-coding application of the tool 100. For example, indicators 802 are indicative of buildings including the one or more roofs that are being monitored by the tool 100, as defined by a legend 804. The indicators 802 may be encoded with, for example, a color-coding to reflect the one or more color-conditions (i.e., as color-coded indicators 802). An encoded indicator 806 may be encoded with a green color-coding to association with a customer as defined by a legend 804. For example, FIG. 8 illustrates as an encoded indicator 806 a roof of a home belong to a selected customer, selected from the drop-down menu 706 of the GUI 700. Further, an encoded indicator 808 may be encoded with a grey color-coding associated with hail damage as defined by the legend 804, and an encoded indicator 810 may be encoded with a blue color-coding associated with wind damage as defined by the legend 804. Further, an indicator 812 may be encoded with a red color-coding associated with hail damage as defined by the legend 804. FIG. 8 does not show any indicators 802 including an encoded color-coding for an encoded indicator 812 that would indicate tornado damage to a roof of a building virtually and visually represented by an indicator 802.

Additionally, different color-coding associations utilizing different colors and different color-coded matching between colors and types of damage are within the scope of this disclosure. Further, the user may be able to see previous reporting outside of the set time window by utilizing a sliding scale feature to view roof information and visual conditions associated with a specific date, for example.

In step 208, an alert may be triggered as well as a call for scheduling a roof damage inspection at least partially based on the associated parameters of a roof being met. For example, a first building with a first roof that is old and has a set hail accumulation parameter of 1 inch may have recently underwent weather conditions reported to the tool 100 of about 2 inches of hail. The tool 100 would then virtually color-code the roof on the virtual map (i.e., on a mapping interface) with a grey indicator indicative of hail damage and trigger an alert to at least one and/or to all of the levels of security-clearance users. Thus, a homeowner, an inspector assigned to the home, an agency to which the inspector belongs, and other tool support administrators will all be sent the triggered alert of potential hail damage to the roof of the home. The alert may include, for example, a push notification message sent through email and/or text message. Other like types of electronically submitted alert notifications are within the scope of this disclosure. In addition, the alert may include a message about a call for a roof damage inspection to be expected at the home within a 24-48 hour period or other reasonable and settable time period (i.e., a trigger period). Thus, the tool 100 may schedule a damage inspection within the trigger period based on stored weather data meeting at least one parameter of a set of parameters for the roof, and the tool 100 may store a received report from the damage inspection within the trigger period. The tool 100 may receive a roof damage claim for the roof form a range of time before the trigger period (for example, less than about 72 hours from the trigger period), and may verify the roof damage claim against a received benchmark inspection report, the received report from the damage inspection within the trigger period, and the stored weather data associated with the roof. In embodiments, the tool 100 may provide certain accessibility levels notifications if a damage inspection has not been documented within the set time period (i.e., the trigger period).

Once the alert has been issued, the assigned inspector, and/or another HAAG certified inspector, for example, may be dispatched to the home to input and store another inspection report from the damage inspection in the central portal in step 210 to document if any roof damage occurred that would be associated with the storm that triggered the alert. In embodiments, a cost associated with the triggered damage inspection may be applied as a credit toward the cost of any resulting repair or replacement for the affected and inspected roof.

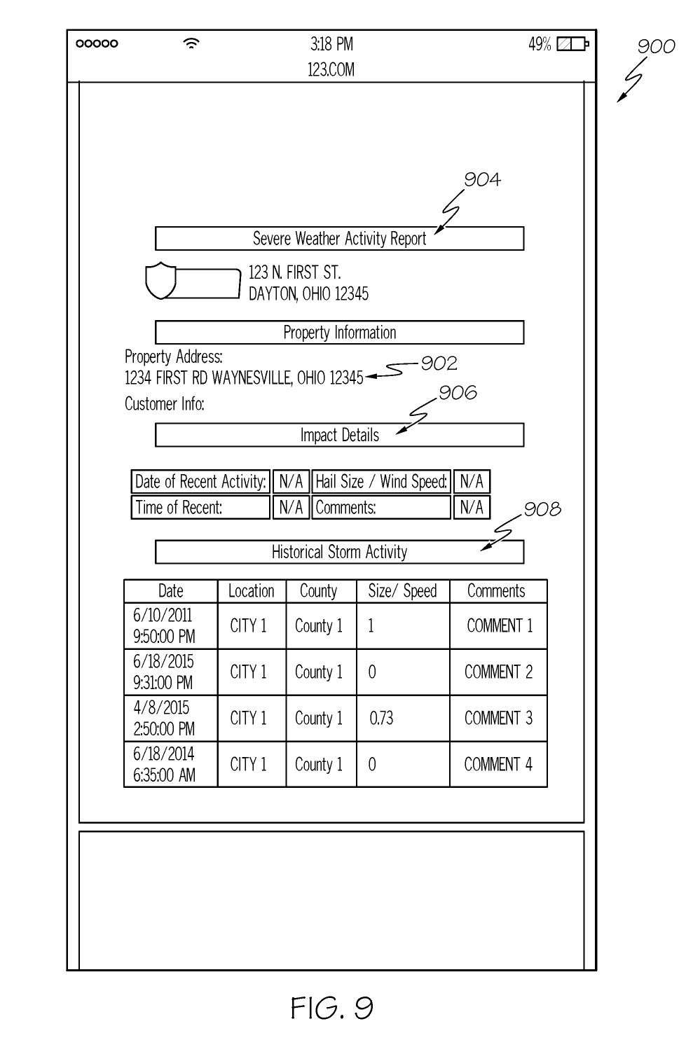

In embodiments, the tool 100 may be used to verify a roof damage claim. For example, a roof may have a stored benchmark inspection report that records that a roof is in good condition and is undamaged at the time of the benchmark report. A claim may be submitted for roof damage after the initial benchmark inspection report has been stored. The tool 100 will be able to track the weather conditions associated with the roof within the period between the claim submission and the initial benchmark report to verify the possibility of a weather condition that may have damaged the roof to the level that is being claimed. If there has been no record of such weather to cause such damage, the claim may be contested as a potentially fraudulent claim. Previous claims and associated inspection reports may further be stored and viewable in the central portal associated with the tool 100. Thus, previously contested and/or uncontested claims may be made available to an inspector investigating, for example, a current claim. The previous history may be provided for a settable timeframe, such as for about the last 5 years. The tool 100 may be able to generate one or more weather history related reports such as one illustrated via GUI 900 of FIG. 9, associated with the tool 100 of FIG. 1 and implemented by the system of FIG. 3, which is described in greater detail further below. FIG. 9 illustrates an example GUI 900 displaying, for a selected property 902, a severe weather activity report 904 that includes an impact details section 906 and a historical storm activity section 908. The impact details section 906 may include information such as a date of a recent activity, a time of the recent activity, the reported and/or monitored hail size and/or wind speed associated with the recent activity, and/or any additional comments regarding the recent activity or other notable item. The historical storm activity section 908 may include information from previous weather related activity reporting for the selected property 902. The information may present a date and time of the activity, a location such as, for example, a city (i.e., City 1, such as Waynesville and/or a direction with respect to Waynesville), and a directional indicator reporting upon a direction with respect to the location and the selected property of the weather related activity. The information may further present a county associated with the location (i.e., County 1, such as Warren), a recorded hail size and/or wind speed associated with the weather related activity, and additional comments. For example, the GUI 900 of FIG. 9 shows a report indicating a history of weather related activity for the selected property 902 such as a reported activity from 2011 of 1 inch hail, a reported activity from 2014 as a comment (i.e., Comment 4, which may be, for example, a comment of a microburst accounting for wind damage to trees and power poles in the vicinity), a reported activity from April of 2015 of 0.73 inches of hail, and a reported activity from June of 2015 as another comment (i.e., Comment 2, which may be a comment of several tree limbs down along a specified road with a time estimated from a radar).

In embodiments, the tool 100 may be further used to schedule roof inspections, such as 30 day inspections from an initial benchmark or other inspection to determined whether a roof may be plated such that a plate indicated level of roof quality (associated with a standard set by a roofing company and having an associated warranty, for example) is physically attached to the inspected roof.

Referring to FIG. 3, a system 300 for implementing a computer and software-based method to utilize the tools, as shown in FIGS. 1 and 2, is illustrated as being implemented along with using a GUI displaying, for example, an electronic display page (displayable on an internal or external website or other technology platform) and that is accessible at a user workstation (e.g., a computer 324), for example. The system 300 includes a communication path 302, one or more processors 304, a memory component 306, a customizable weather tracking component 312, a storage or database 314, an application component 316, a network interface hardware 318, a network 322, a server 320, and at least one computer 324. The various components of the system 300 and the interaction thereof will be described in detail below.

While only one application server 320 and one user workstation computer 324 is illustrated, the system 300 can include multiple workstations and application servers containing one or more applications that can be located at geographically diverse locations across a plurality of sites. In some embodiments, the system 300 is implemented using a wide area network (WAN) or network 322, such as an intranet or the Internet. The workstation computer 324 may include digital systems and other devices permitting connection to and navigation of the network. Other system 300 variations allowing for communication between various geographically diverse components are possible. The lines depicted in FIG. 3 indicate communication rather than physical connections between the various components.

As noted above, the system 300 includes the communication path 302. The communication path 302 may be formed from any medium that is capable of transmitting a signal such as, for example, conductive wires, conductive traces, optical waveguides, or the like, or from a combination of mediums capable of transmitting signals. The communication path 302 communicatively couples the various components of the system 300. As used herein, the term “communicatively coupled” means that coupled components are capable of exchanging data signals with one another such as, for example, electrical signals via conductive medium, electromagnetic signals via air, optical signals via optical waveguides, and the like.

As noted above, the system 300 includes the processor 304. The processor 304 can be any device capable of executing machine readable instructions. Accordingly, the processor 304 may be a controller, an integrated circuit, a microchip, a computer, or any other computing device. The processor 304 is communicatively coupled to the other components of the system 300 by the communication path 302. Accordingly, the communication path 302 may communicatively couple any number of processors with one another, and allow the modules coupled to the communication path 302 to operate in a distributed computing environment. Specifically, each of the modules can operate as a node that may send and/or receive data.

As noted above, the system 300 includes the memory component 306 which is coupled to the communication path 302 and communicatively coupled to the processor 304. The memory component 306 may be a non-transitory computer readable medium or non-transitory computer readable memory and may be configured as a nonvolatile computer readable medium. The memory component 306 may comprise RAM, ROM, flash memories, hard drives, or any device capable of storing machine readable instructions such that the machine readable instructions can be accessed and executed by the processor 304. The machine readable instructions may comprise logic or algorithm(s) written in any programming language such as, for example, machine language that may be directly executed by the processor, or assembly language, object-oriented programming (OOP), scripting languages, microcode, etc., that may be compiled or assembled into machine readable instructions and stored on the memory component 306. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. In embodiments, the system 300 may include the processor 304 communicatively coupled to the memory component 306 that stores instructions that, when executed by the processor 304, cause the processor to perform one or more tool functions as described herein.

Still referring to FIG. 3, as noted above, the system 300 comprises the display such as a GUI on a screen of the computer 324 for providing visual output such as, for example, information, graphical reports, messages, or a combination thereof. The GUI may present and display results from the customizable weather tracking component 312, as described in greater detail below. The display on the screen of the computer 324 is coupled to the communication path 302 and communicatively coupled to the processor 304. Accordingly, the communication path 302 communicatively couples the display to other modules of the system 300. The display can include any medium capable of transmitting an optical output such as, for example, a cathode ray tube, light emitting diodes, a liquid crystal display, a plasma display, or the like. Additionally, it is noted that the display or the computer 324 can include at least one of the processor 304 and the memory component 306. While the system 300 is illustrated as a single, integrated system in FIG. 3, in other embodiments, the systems can be independent systems.

The system 300 comprises the application component 316 that allows a user to view and/or add roof inspection reports of a number of physical roof sites and an associated, customizable weather tracking component 312 to virtually overlay weather condition indicators at least partially based on set parameters on respective ones of the physical roof sites on a GUI via the application component 316, as described above. The application component 316 and the customizable weather tracking component 312 are coupled to the communication path 302 and communicatively coupled to the processor 304. As will be described in further detail below, the processor 304 may process the input signals received from the system modules and/or extract information from such signals.

The system 300 includes the network interface hardware 318 for communicatively coupling the system 300 with a computer network such as network 322. The network interface hardware 318 is coupled to the communication path 302 such that the communication path 302 communicatively couples the network interface hardware 318 to other modules of the system 300. The network interface hardware 318 can be any device capable of transmitting and/or receiving data via a wireless network. Accordingly, the network interface hardware 318 can include a communication transceiver for sending and/or receiving data according to any wireless communication standard. For example, the network interface hardware 318 can include a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 3, data from various applications running on computer 324 can be provided from the computer 324 to the system 300 via the network interface hardware 318. The computer 324 can be any device having hardware (e.g., chipsets, processors, memory, etc.) for communicatively coupling with the network interface hardware 318 and a network 322. Specifically, the computer 324 can include an input device having an antenna for communicating over one or more of the wireless computer networks described above.

The network 322 can include any wired and/or wireless network such as, for example, wide area networks, metropolitan area networks, the Internet, an Intranet, satellite networks, or the like. Accordingly, the network 322 can be utilized as a wireless access point by the computer 324 to access one or more servers (e.g., a server 320). The server 320 and any additional servers generally include processors, memory, and chipset for delivering resources via the network 322. Resources can include providing, for example, processing, storage, software, and information from the server 320 to the system 300 via the network 322. Additionally, it is noted that the server 320 and any additional servers can share resources with one another over the network 322 such as, for example, via the wired portion of the network, the wireless portion of the network, or combinations thereof.

The tools described herein permit various levels of users to access portions of the tool based on levels of security clearance and permit a level of sharing across such users for a specific roof of a specific building, for example. A homeowner may be able to access his or her own home-specific roofing reports and view the associated weather conditions, an inspector assigned to the homeowner may be able to the access the reports and view the associated weather conditions as well, and/or high levels of security clearance users may be able to view the reports across inspectors and view the associated weather conditions for the roofs of those customers assigned to those inspectors. Further, reporting may be available across the roofs to generate information regarding the number of homes in an assignable area (whether available to an inspector, across inspectors, or to an otherwise monitored area users) that are affected by a specific storm or weather condition and/or the number of triggered alerts that may be compared to the number of contested and/or uncontested resulting claims. Use of the tools described herein provided a streamlined and more efficient method and manner of reporting and monitoring storm damage to roofs and/or automatically, dynamically, and visually providing a first level of verification of roof damage claims (that may be followed up, for example, by additional verification through damage inspection reports to be stored in the tools). Further, with the tools described herein, a user is able to track the history of a home (or a plurality of buildings depending on, for example, a user's level of security clearance) to determined current and previous roof conditions. A user may also adjust weather parameters associated with different types of roofs and/or roofs of different ages. Thus, a more streamlined and efficiency increasing method of monitoring and reporting upon roofs and roof conditions through the tools described herein improve the field of roof inspection and insurance claim verification by providing automated and real-time trackable roofing reports as described herein.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for utilizing a computing device to store a history of roof information for a building with corresponding weather information associated with the building over a period of time, the method comprising:
storing a set of parameters for the roof indicative of potential roof damage conditions;
monitoring weather associated with the roof;
automatically storing, via a processor of the computing device, the monitored weather as stored weather data associated with the roof; and
triggering, via the processor, an alert based on the stored weather data meeting at least one parameter of the set of parameters for the roof.

2. The method of claim 1, further comprising scheduling a damage inspection within a trigger period based on the stored weather data meeting at least one parameter of the set of parameters for the roof.

3. The method of claim 2, further comprising storing a received report from the damage inspection within the trigger period.

4. The method of claim 3, further comprising:
storing a received benchmark inspection report of a roof of the building;
receiving a roof damage claim for the roof from a range of time before the trigger period; and
verifying the roof damage claim against the received benchmark inspection report, the received report from the damage inspection within the trigger period, and the stored weather data associated with the roof.

5. The method of claim 3, wherein the range of time before the trigger period is less than about 72 hours from the trigger period.

6. The method of claim 1, further comprising displaying one or more color-coded conditions of at least the roof in real-time on a mapping interface on the computing device based on the set of parameters for the roof and the stored weather data associated with the roof.

7. The method of claim 6, wherein the one or more color-coded conditions comprise:
a first color-coding indicative of no current damage;
a second color-coding indicative of wind damage and different from the first color-coding;
a third color-coding indicative of hail damage and different from the first color-coding and the second color-coding; and
a fourth color-coding indicative of tornado damage and different from the first color-coding, the second color-coding, and the third color-coding.

8. The method of claim 6, wherein the one or more color-coded conditions comprise:
a fifth color-coding different from the first color-coding, the second color-coding, and the third color-coding and indicative of the roof from a plurality of roof data respectively associated with a plurality of buildings stored in the computing device.

9. The method of claim 1, further comprising setting by a user and via a user interface the set of parameters for the roof indicative of potential roof damage conditions.

10. The method of claim 9, wherein the at least one parameter comprises a set wind parameter for wind gusts in a range of from about 20 miles per hour to about 40 miles per hour.

11. The method of claim 9, wherein the at least one parameter comprises:
a set first level potential tornado parameter for wind gusts in a range of from about 40 miles per hour to about 72 miles per hour;
a set second level potential tornado parameter for wind gusts in a range of from about 73 miles per hour to about 112 miles per hour;
a set third level potential tornado parameter for wind gusts in a range of from about 113 miles per hour to about 157 miles per hour;
a set fourth level potential tornado parameter for wind gusts in a range of from about 158 miles per hour to about 206 miles per hour; and
a set fifth level potential tornado parameter for wind gusts in a range of from about 207 miles per hour to about 260 miles per hour;
a set sixth level potential tornado parameter for wind gusts in a range of from about 261 miles per hour to about 318 miles per hour; and
a set seventh level potential tornado parameter for wind gusts greater than 318 miles per hour.

12. The method of claim 9, wherein the at least one parameter comprises a set old roof hail parameter for hail accumulation of greater than 1 inch for a roof age of the roof that is greater than about 10 years.

13. The method of claim 9, wherein the at least one parameter comprises a set new roof hail parameter for hail accumulation of greater than 1.75 inches for a roof age of the roof that is less than about 10 years.

14. The method of claim 1, further comprising:
displaying on a graphical user interface of the computing device a weather history report for the roof over a window of time from a portion of the period of time.

15. The method of claim 1, wherein the alert comprises a push notification message sent to a user of the computing device through at least one of an email message and a text message.

16. The method of claim 15, wherein the user comprises an assigned user level of one of an inspector of the roof, an administrator of the computing device, and a customer of the roof, and the user is assigned respective security clearance rights with respect to access of one or more levels of the computing device based on the assigned user level.

17. A system for utilizing a computing device to store a history of roof information for a building with corresponding weather information associated with the building over a period of time, the system comprising:
a server communicatively coupled to the computing device;
a processor communicatively coupled to the server;
a non-transitory computer-readable storage medium storing one or more instructions that, when executed by the processor, cause the processor to:
store a set of parameters for the roof indicative of potential roof damage conditions;
monitor weather associated with the roof through a weather monitoring application communicatively coupled to the computing device;
automatically store the monitored weather as stored weather data associated with the roof; and
trigger an alert based on the stored weather data meeting at least one parameter of the set of parameters for the roof.

18. The system of claim 17, wherein the one or more instructions further cause the processor to:
schedule a damage inspection within a trigger period based on the stored weather data meeting at least one parameter of the set of parameters for the roof;
store a received report from the damage inspection within the trigger period;
store a received benchmark inspection report of a roof of the building; and
receive a roof damage claim for the roof from a range of time before the trigger period; and
verify the roof damage claim against the received benchmark inspection report, the received report from the damage inspection within the trigger period, and the stored weather data associated with the roof.

19. A system for utilizing a computing device to store a history of roof information for a building with corresponding weather information associated with the building over a period of time, the system comprising:
a graphical user interface of the computing device;
a server communicatively coupled to the computing device;
a processor communicatively coupled to the server;
a non-transitory computer-readable storage medium storing one or more instructions that, when executed by the processor, cause the processor to:
store a set of parameters for the roof indicative of potential roof damage conditions;
monitor weather associated with the roof through a weather monitoring application communicatively coupled to the computing device;
automatically store the monitored weather as stored weather data associated with the roof;
display one or more color-coded conditions of at least the roof in real-time on a map on the graphical user interface of the computing device based on the set of parameters for the roof and the stored weather data associated with the roof; and
trigger an alert based on the stored weather data meeting at least one parameter of the set of parameters for the roof.

20. The system of claim 19, wherein the one or more instructions further cause the processor to:
display on the map roof data from a plurality of roof data respectively associated with a plurality of buildings stored in the computing device; wherein the one or more color-coded conditions are configured for display with respect to the plurality of roof data and comprise:
a first color-coding indicative of no current damage;
a second color-coding indicative of wind damage and different from the first color-coding;
a third color-coding indicative of hail damage and different from the first color-coding and the second color-coding;
a fourth color-coding indicative of tornado damage and different from the first color-coding, the second color-coding, and the third color-coding; and
a fifth color-coding indicative of the roof from the plurality of roof data and a position of the roof on the map and different from the first color-coding, the second color-coding, and the third color-coding.
